(19) United States
(12) Patent Application Publication
(10) Pub. No.: US 2009/0002554 A1
(43) Pub. Date: Jan. 1, 2009

(54) ELECTRIC FIELD EFFECT READ/WRITE HEAD, METHOD OF MANUFACTURING THE SAME, AND ELECTRIC FIELD EFFECT STORAGE APPARATUS HAVING THE SAME

(75) Inventor: Shin-haeng Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/125,596

(22) Filed: May 22, 2008

(30) Foreign Application Priority Data
Jun. 28, 2007 (KR) 10-2007-0064435

(51) Int. Cl. H04N 9/475

(52) U.S. Cl. 348/513; 348/E09.034

(57) ABSTRACT

An image display apparatus and method which remove double edges are provided. The image display apparatus includes a first driving unit which generates pulse signals indicating the beginning of each of a plurality of frames which constitute an image signal reproduced by adjusting a frame rate of an image signal, a second driving unit which performs impulsive driving while the pulse signals are generated, and a third driving unit which displays the frames received after the impulsive driving on a display.

### CROSS-REFERENCE TO RELATED APPLICATIONS

This application claims priority under 35 U.S.C. § 119 from Korean Patent Application No. 10-2007-0064435, filed on Jun. 28, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to providing an image display apparatus which removes double edges by performing multiple speed driving of an image frequency and performing impulsive driving when a response time is sufficiently completed, and a method thereof.

2. Description of the Related Art

Display apparatuses, such as liquid crystal displays (LCDs) and plasma display panels (PDPs), which have become widely used, use hold-type displays which keep displaying a prior frame until a new image is displayed. When a displayed image changes to a subsequent image, a certain response time is necessary to either charge or discharge voltage, or rotate liquid crystals in the display, depending on the type of display. Accordingly, when moving images are displayed, motion blur phenomena such as afterimages occur, so image quality degrades.

In order to prevent motion blur phenomena, impulsive driving methods, in which image data is applied to a certain section of a single frame and black data is applied to the remainder of the frame, or backlights are sequentially lit, have been suggested.

However, if images are displayed using an impulsive driving method, the image is not displayed continuously during a single frame. Accordingly, the luminance is reduced and flickering occurs. To some extent, flickering is addressed by using dual pulse scanning, but double edges still occur in rapidly moving images.

FIGS. 1A and 1B illustrate double edges generated by a related art scanning method.

If a white rectangle 110a in a black background 100 of FIG. 1A moves left horizontally, a black line is generated on a white rectangle 110b and a white line is generated on the black background 100 as shown in FIG. 1B, that is, double edges occur.

In order to address such double edges, a method for adaptively applying dual pulse scanning and single pulse scanning to movement has been suggested.

Such a method addresses the noted problems to some extent, but scanning a moving object still generates double edges.

Therefore, there is a need for methods for removing double edges.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

An aspect of the present invention provides a display apparatus which reduces a response time by multiple speed driving of input images and performs scanning when the response time is sufficiently completed so that double edges and dynamic movement can be effectively removed, and a display method thereof.

According to an exemplary aspect of the present invention, there is provided an image display apparatus comprising a first driving unit which generates a first pulse signal indicating the beginning of each of the frames constituting an image signal reproduced by adjusting a frame rate of an image signal and a second pulse signal indicating the beginning of each of frames added to adjust the frame rate of the image signal, a second driving unit which performs the impulsive driving from the time when the first pulse signal and the second pulse signal overlap until the time when the following first pulse signal appears, and a third driving unit which displays the frames received after the impulsive driving on a display.

The frames added to adjust the frame rate of the image signal may be inserted between the frames constituting the image signal before the image signal is reproduced.

The impulsive driving may be performed a predetermined period of time after the first pulse signal and the second pulse signal overlap.

The frame rate of the image signal may be multiplied by an integer or non-integer.

According to another exemplary aspect of the present invention, there is provided an image display method comprising generating a first pulse signal indicating the beginning of each of the frames constituting an image signal reproduced by adjusting a frame rate of an image signal and a second pulse signal indicating the beginning of each of frames added to adjust the frame rate of the image signal, performing the impulsive driving from the time when the first pulse signal and the second pulse signal overlap until the time when the following first pulse signal appears, and displaying the frames received after the impulsive driving on a display.

### BRIEF DESCRIPTION OF THE DRAWINGS

The above and/or other aspects of the present invention will be more apparent by describing certain exemplary embodiments of the present invention with reference to the accompanying drawings, in which:

FIGS. 1A and 1B illustrate double edges generated by using a related art scanning method;

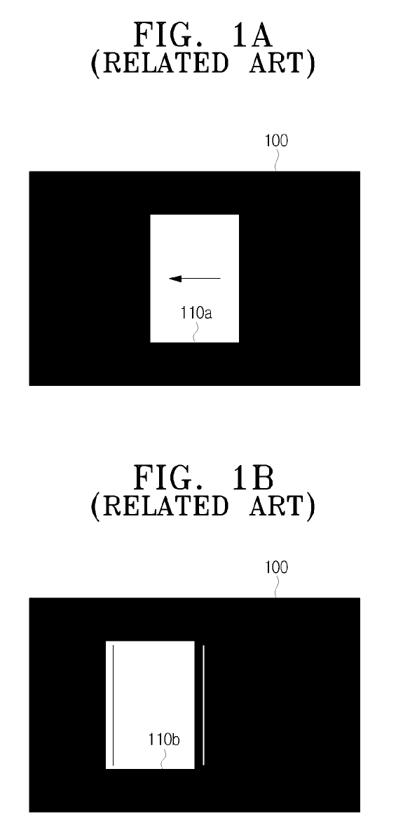

FIG. 2 is a block diagram of an image display apparatus according to an exemplary embodiment of the present invention;

FIG. 3 is a drawing provided to describe an impulsive driving method according to an exemplary embodiment of the present invention; and

FIG. 4 is a flowchart illustrating an impulsive driving method according to an exemplary embodiment of the present invention.

### DETAILED DESCRIPTION OF EXEMPLARY EMBODIMENTS OF THE INVENTION

Certain exemplary embodiments of the present invention will now be described in greater detail with reference to the accompanying drawings.

In the following description, like drawing reference numerals are used for like elements, even in different drawings. The matters defined in the description, such as detailed construction and elements, are provided to assist in a comprehensive understanding of the invention. However, the present invention can be practiced without those specifically defined matters. Also, well-known functions or constructions are not described in detail since they would obscure the invention with unnecessary detail.

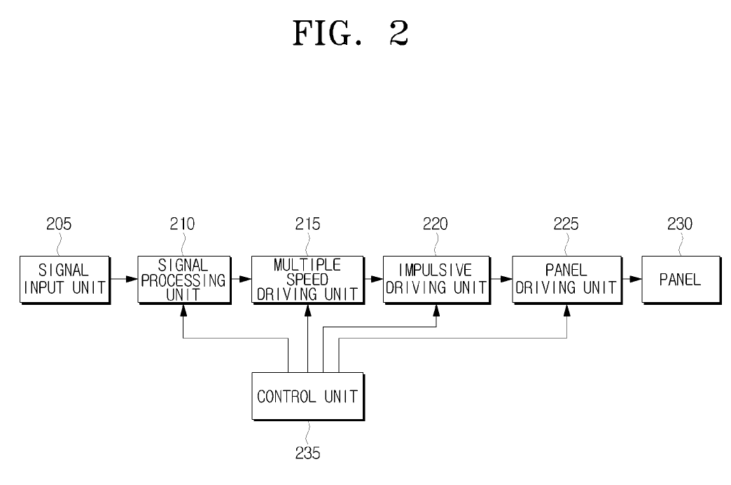

FIG. 2 is a block diagram of an image display apparatus according to an exemplary embodiment of the present invention.

In FIG. 2, the image display apparatus includes a signal input unit 205, a signal processing unit 210, a multiple speed driving unit 215, an impulsive driving unit 220, a panel driving unit 225, a panel 230, and a control unit 235.

The signal input unit 205 receives an image signal from an external device (not shown) through a tuner or an input terminal.

The signal processing unit 210 receives the image signal from the signal input unit 205 and processes the image signal to be displayed on the panel 230 under the control of the control unit 235.

The multiple speed driving unit 215 adjusts the frame rate of the processed image signal and thereby generates a first pulse signal indicating the beginning of the frames constituting the adjusted image signal and a second pulse signal indicating the beginning of the frames added to adjust the frame rate.

In greater detail, the multiple speed driving unit 215 multiplies the frequency of an input image signal by a predetermined number, so the same frames are repeated the predetermined number of times. In addition, the multiple speed driving unit 215 generates a first pulse signal indicating the beginning of all the frames constituting the frame-rate-adjusted image signal and a second pulse signal indicating the beginning of all the frames added to adjust the frame rate.

For example, if the multiple speed driving unit 215 performs double speed driving of an image input at a frequency of 60 Hz, the frequency of the image signal is adjusted to 120 Hz and a single frame becomes two frames. A first pulse signal indicating the beginning of the frames constituting a reproduced image signal based on the turned frequency of 120 Hz and a second pulse signal indicating the beginning of the frames added to adjust the frame rate are generated.

Moreover, the multiple speed driving unit 215 may multiply the frame rate of an image signal by an integer or non-integer.

In addition to the function of adjusting the frame rate of an image signal by a predetermined number as described above, the multiple speed driving unit 215 may have a function of compensating for jittering when displaying a moving object so that the effect of movement may be removed when reproducing an image.

The impulsive driving unit 220 performs impulsive driving based on the first pulse signal and second pulse signal received from the multiple speed driving unit 215.

More specifically, the impulsive driving unit 220 performs impulsive driving using a backlight scanning method or a black frame inserting method. The backlight scanning method artificially removes afterimages of moving images by rapidly flickering backlights in sequence from the time the first pulse signal and the second pulse signal overlap until the time the following first pulse signal appears. In the black frame inserting method, during a period of time in which a single frame is displayed, the frame is displayed for a part of the period of time and a black frame is inserted and displayed for the remaining period of time.

The time that the first pulse signal and the second pulse signal overlap is the time that a response time is sufficiently completed in a single frame. Accordingly, impulsive driving is performed using the backlight scanning method or the black frame inserting method after the time that the first pulse signal and the second pulse signal overlap, so that generation of double edges can be prevented when frames are shifted.

The impulsive driving unit 220 may also start impulsive driving a predetermined period of time after the first pulse signal and the second pulse signal overlap. In the case that the response time is not completed at a sufficient level, impulsive driving may be performed when the response time is sufficiently completed after the predetermined period of time.

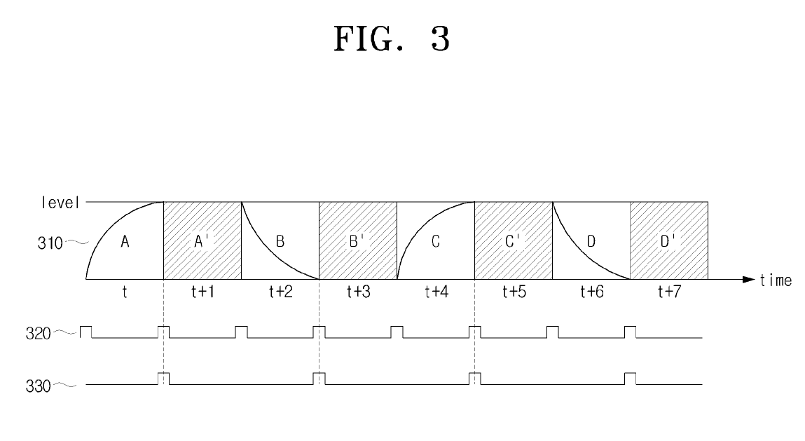

This is described below in detail with reference to FIG. 3 which is a drawing provided to describe an impulsive driving method according to an exemplary embodiment of the present invention.

In FIG. 3, frames (A, A′, B, B′, C, C′, D, and D′) of an image signal are reproduced by adjusting the frame rate of the image signal including frames (A, B, C, and D) of 60 Hz to 120 Hz using the multiple speed driving unit 215. As the frames are changed, a response curve 310 is displayed to a predetermined level. A first pulse signal 320 indicating the beginning of frames (A, A′, B, B′, C, C′, D, and D′) constituting the adjusted image signal and a second pulse signal 330 indicating the beginning of frames (A′, B′, C′, and D′) added to adjust the frame rate are shown.

The impulsive driving unit 220 performs impulsive driving from when the first pulse signal 320 and the second pulse signal 330 coincide (t, t+2, t+4, and t+6) until the following first pulse signal 320 appears (t+1, t+3, t+5, and t+7).

Consequently, impulsive driving is performed when the response curve 310 in a single frame reaches a sufficient level.

The panel driving unit 225 drives the panel 230 to display the frames received after the impulsive driving.

The control unit 235 controls the overall operation of the image display apparatus.

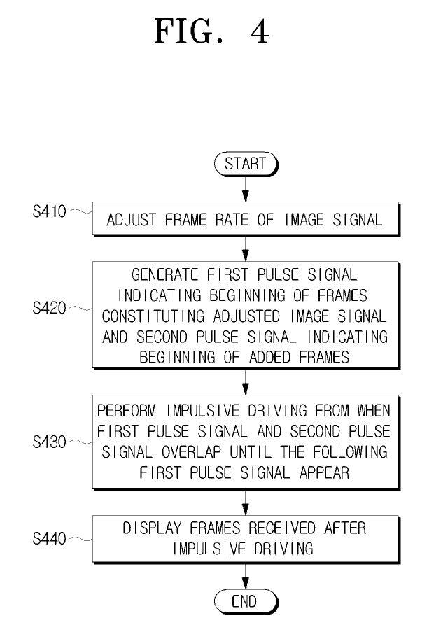

Hereinafter, a method for removing double edges using an image display apparatus as shown in FIG. 2 is described in detail with reference to FIG. 4, which is a flowchart illustrating an impulsive driving method according to an exemplary embodiment of the present invention.

The multiple speed driving unit 215 adjusts the frame rate of an input image signal (S410). In more detail, the multiple speed driving unit 215 multiplies the frame rate of an image signal by an integer or non-integer.

While the frame rate is adjusted, the multiple speed driving unit 215 generates a first pulse signal indicating the beginning of the frames constituting the adjusted image signal and a second pulse signal indicating the beginning of the added frames (S420).

That is, the multiple speed driving unit 215 multiplies the frequency of an input image signal by a predetermined number, so the same frames are repeated the predetermined number of times, and at the same time, outputs a first pulse signal indicating the beginning of each of the frames constituting the image signal reproduced by adjusting the frame rate and a second pulse signal indicating the beginning of each of the frames added to adjust the frame rate.

Subsequently, the impulsive driving unit 220 performs impulsive driving from the time the first pulse signal and the second pulse signal overlap until the following first pulse signal appears (S430). More specifically, the impulsive driving unit 220 performs impulsive driving using a backlight scanning method or a black frame inserting method when the first pulse signal and the second pulse signal overlap, that is, the response time is sufficiently completed in a single frame, so that generation of double edges can be prevented when frames are shifted.

Moreover, the impulsive driving unit 220 may also start impulsive driving a predetermined period of time after the first pulse signal and the second pulse signal overlap. In the case that the response time is not completed sufficiently, impulsive driving is performed when a response time is sufficiently completed after the predetermined period of time.

The panel driving unit 225 drives the panel 230 to display the frames received after the impulsive driving of the impulsive driving unit 220 (S440).

The foregoing exemplary embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

For example, in the exemplary embodiment, a backlight scanning and black frame inserting method are used for impulsive driving, which is a method for compensating motion blur effect, to output the frames when the first pulse signal and the second pulse signal overlap. However, other methods for compensating motion blur effect can also be applied.

As can be appreciated from the above description, generation of double edges and dynamic movement can be effectively removed by reducing a response time by multiple speed driving and performing impulsive driving when the response time is sufficiently completed according to an exemplary embodiment of the instant invention.

What is claimed is:

1. An image display apparatus, comprising:
a first driving unit which generates pulse signals indicating beginnings of a plurality of frames of an image signal reproduced by adjusting a frame rate of the image signal;
a second driving unit which performs impulsive driving while the pulse signals are generated; and
a third driving unit which displays the plurality of frames received after the impulsive driving, on a display.

2. The image display apparatus of claim 1, wherein the pulse signals comprise a first pulse signal which indicate a beginning one of the plurality of frames and a second pulse signal which indicates a beginning of a another of the plurality of frames added to adjust the frame rate of the image signal.

3. The image display apparatus of claim 2, wherein the second driving unit performs the impulsive driving from a time when the first pulse signal and the second pulse signal overlap until a time when a following first pulse signal appears.

4. The image display apparatus of claim 3, wherein the second driving unit performs the impulsive driving at a predetermined period of time after the first pulse signal and the second pulse signal overlap.

5. The image display apparatus of claim 2, wherein the second driving unit performs the impulsive driving using at least one of a backlight scanning method, which sequentially flickers backlights, and a black frame inserting method, which inserts and displays black frames.

6. The image display apparatus of claim 1, wherein frames added to adjust the frame rate of the image signal are inserted between the plurality of frames of the image signal before the image signal is reproduced.

7. The image display apparatus of claim 1, wherein the first driving unit multiplies the frame rate of the image signal by an integer.

8. An image display method, comprising:
generating pulse signals indicating beginnings of a plurality of frames of an image signal reproduced by adjusting a frame rate of the image signal;
performing impulsive driving while the pulse signals are generated; and
displaying the plurality of frames received after the impulsive driving, on a display.

9. The image display method of claim 8, wherein the pulse signals comprise a first pulse signal indicating a beginning one of the plurality of frames, and a second pulse signal indicating a beginning of another of the plurality of frames added to adjust the frame rate of the image signal.

10. The image display method of claim 9, wherein in the operation of performing the impulsive driving, the impulsive driving is performed from a time when the first pulse signal and the second pulse signal overlap until a time when a following first pulse signal appears.

11. The image display method of claim 10, wherein in the operation of performing the impulsive driving, the impulsive driving is performed at a predetermined period of time after the first pulse signal and the second pulse signal overlap.

12. The image display method of claim 9, wherein in the operation of performing the impulsive driving, the impulsive driving is performed using at least one of a backlight scanning method, which sequentially flickers backlights, and a black frame inserting method, which inserts and displays black frames.

13. The image display method of claim 8, wherein frames added to adjust the frame rate of the image signal are inserted between the plurality of frames of the image signal before the image signal is reproduced.

14. The image display method of claim 8, wherein in the operation of adjusting the frame rate of the image signal, the frame rate of the image signal is multiplied by an integer.

15. The image display method of claim 8, wherein in the adjusting the frame rate of the image signal, the frame rate of the image signal is multiplied by a non-integer.

16. The image display apparatus of claim 1, wherein the first driving unit multiplies the frame rate of the image signal by an non-integer.
